(19) United States
(12) Patent Application Publication
(10) Pub. No.: US 2011/0076420 A1
(43) Pub. Date: Mar. 31, 2011

(54) HIGH EFFICIENCY LOW ENERGY MICROWAVE ION/ELECTRON SOURCE

(75) Inventor: Michael W. Stowell, Loveland, CO (US)

(73) Assignee: Applied Materials, Inc., Santa Clara, CA (US)

(21) Appl. No.: 12/833,473

(22) Filed: Jul. 9, 2010

Related U.S. Application Data
(63) Continuation-in-part of application No. PCT/US2008/052383, filed on Jan. 30, 2008.
(60) Provisional application No. 61/224,224, filed on Jul. 9, 2009.
(60) Provisional application No. 61/224,234, filed on Jul. 9, 2009.
(60) Provisional application No. 61/224,371, filed on Jul. 9, 2009.
(60) Provisional application No. 61/224,245, filed on Jul. 9, 2009.

(51) Int. Cl. H05H 1/24

(52) U.S. Cl. 427/569; 118/723 MW

(57) ABSTRACT

A microwave charged particle source is provided according to various embodiments of the invention. The microwave charged particle source can include a coaxial antenna for generating microwaves and a dielectric layer surrounding the antenna. The microwave charged particle source can also include a first gas line outside the dielectric layer for providing sputtering gases and/or a second gas line for providing cooling gas in a space between the antenna and dielectric layer. The microwave charged particle source can further include a containment shield partially surrounding the dielectric layer and an extraction grid disposed on or near an aperture in the containment shield. In use, charged particles can be formed with the generated microwaves from sputtering gases. And the charged particles can be accelerated under an electric field created from a voltage applied to the extraction grid. A method for providing microwave charged particle source is also provided.

### CROSS-REFERENCES TO RELATED APPLICATIONS

This patent application is a non-provisional of and claims the benefit of U.S. Provisional Patent Application No. 61/224,224, entitled “High Efficiency Low Energy Microwave Ion/Electron Source,” filed Jul. 9, 2009, the entire disclosures of which are incorporated herein by reference for all purposes.

This patent application is a non-provisional of and claims the benefit of U.S. Provisional Patent Application No. 61/224,234, entitled “Curved Surface Wave Fired Plasma Line for Coating of 3 Dimensional Substrates,” filed Jul. 9, 2009, the entire disclosures of which are incorporated herein by reference for all purposes.

This patent application is a non-provisional of and claims the benefit of U.S. Provisional Patent Application No. 61/224,371, entitled “Simultaneous Vertical Deposition of Plasma Displays Layers,” filed Jul. 9, 2009, the entire disclosures of which are incorporated herein by reference for all purposes.

This patent application is a non-provisional of and claims the benefit of U.S. Provisional Patent Application No. 61/224,245, entitled “Microwave Linear Deposition of Plasma Display Protection Layers,” filed Jul. 9, 2009, the entire disclosures of which are incorporated herein by reference for all purposes.

This patent application is a continuation-in-part application of International Application No. PCT/US2008/052383, entitled “System and Method for Microwave Plasma Species Source,” filed 30 Jan., 2008, the entire disclosures of which are incorporated herein by reference for all purposes.

### BACKGROUND

Glow discharge thin film deposition processes are extensively used for industrial applications and materials research, especially in creating new advanced materials. Although chemical vapor deposition (CVD) generally exhibits superior performance for deposition of materials in trenches or holes, physical vapor deposition (PVD) is sometimes preferred because of its simplicity and lower cost. In PVD, magnetron sputtering is often preferred over non-magnetron sputtering because as it may provide a significant increase in deposition rate, and it may provide a significant decrease in the required discharge pressure. Inert gases such as argon, can be used as sputtering agents because they do not react with target materials. When a negative voltage is applied to a target, positive ions, such as positively charged argon ions, hit the target and knock the atoms out. Secondary electrons can be also ejected from the target surface. A magnetic field can trap the secondary electrons close to the target that can result in more ionizing collisions with inert gases. This can enhance the ionization of the plasma near the target and can lead to a higher sputtering rate. It can also mean that the plasma can be sustained at a lower pressure. Conventional magnetron sputtering has relatively low deposition rate.

Unlike evaporative techniques, the energy of ions or atoms in PVD is comparable to the binding energy of typical surfaces. This can help increase atom mobility and surface chemical reaction rates so that epitaxial growth may occur at reduced temperatures and so that synthesis of chemically metastable materials may be allowed. By using energetic atoms or ions, compound formation may also become easier. An even greater advantage can be achieved if the deposition material is ionized. In this case, the ions can be accelerated to desired energies and guided by using electric or magnetic fields to control film intermixing, nano- or microscale modification of microstructure, and creation of metastable phases. Because of the interest in achieving a deposition flux in the form of ions rather than neutrals, several new ionized physical vapor deposition (IPVD) techniques have been developed to ionize the sputtered material and subsequently direct the ions toward the substrate using a plasma sheath that is generated by using an RF bias on the substrate.

The ionization of atoms requires a high density plasma, which makes it difficult for the deposition atoms to escape without being ionized by energetic electrons. A typical planar discharge system can be driven by a radio-frequency (RF) power supply at 13.56 MHz. When an electric field is generated between two electrodes, atoms are ionized and electrons are released. The planar discharge system utilizes high voltages and magnets to increase electron mean free paths to achieve and sustain a plasma density high enough to allow ion extraction. This typically yields a relatively broad distribution with many ion energies greater than 100 eV, or up to a range of 1000 eV.

Capacitively generated plasmas are usually lightly ionized, resulting in low deposition rate. Denser plasma may be created using inductive discharges. Inductively coupled plasma may have a plasma density of 10¹¹ ions/cm³, approximately 100 times higher than comparable capacitively generated plasma. A typical inductive ionization PVD uses an inductively coupled plasma that is generated by using an internal coil with a 13.56-MHz RF source. A drawback with this technique is that ions with about 100 eV in energy bombard the coil, erode the coils, and then generate sputtered contaminants that may adversely affect the deposition. And the high energy of the ions may damage the substrate. Some improvements can be achieved by using an external coil to solve the problem associated with the internal ICP coil.

Another technique for increasing plasma density is to use a microwave frequency source. At low frequencies, electromagnetic waves do not propagate in a plasma, but are instead reflected. At high frequencies, such as typical microwave frequency, however, electromagnetic waves effectively allow direct heating of plasma electrons. As the microwaves input energy into the plasma, collisions can occur to ionize the plasma so that higher plasma density can be achieved. Typically, horns are used to inject the microwaves or a small stub antenna is placed in the vacuum chamber adjacent to the sputtering cathode for inputting the microwaves into the chamber. But this technique does not provide a homogeneous assist to enhance plasma generation. And it does not provide enough plasma density to sustain its own discharge without the assistance of the sputtering cathode. Additionally, scale up of such systems for large area deposition is limited to a length on the order of 1 meter or less due to non-linearity.

There are many applications for ion sources, among others, including surface cleaning and surface pretreatment for deposition, surface roughening of polymers for improved adhesion, ion beam assisted deposition (IBAD), ionized physical vapor deposition (IPVD), ion implantation, and ion plating. Ion sources can also be used to change the chemistry and structure of thin films during deposition.

While ion sources of high energy levels can be useful for many processes and plasma etching applications, some materials or film deposition processes may require ion sources of lower energy levels, such as sub eV levels. In some applications, ions with high energy may damage the film or surface being treated. Also, ion sources for providing uniform coatings over large areas are limited for use because of relatively high cost and complications.

Therefore, there still remains a need for developing systems and methods for providing ion energy sources of high efficiency and controllable low energy with relatively narrow energy distribution in depositions over large areas.

### BRIEF SUMMARY OF THE INVENTION

Embodiments of the invention utilize a coaxial microwave ion source with a containment shield and an extraction grid to provide a high density plasma from which ions of relatively low energies. The extraction grids may be biased by electric voltage to provide ion energies ranging from a few eVs to several hundred eVs or even a few thousand eVs. This source may also be nonlinearly shaped to provide homogeneous treatment or coating onto complex 3D substrates.

According to one embodiment of the invention, a microwave charged particle source can include a coaxial antenna for generating microwaves and a dielectric layer surrounding the antenna. The microwave charged particle source can also include a first gas line outside the dielectric layer for providing sputtering gases and a containment shield partially surrounding the dielectric layer and having an aperture. The first gas line can be disposed within the containment shield. Charged particles can be formed from the sputtering gases with the generated microwaves. The microwave charge particle source can further include an extraction grid coupled to the aperture of the containment shield. A voltage can be applied to the extraction grid forming a electric field that accelerates the charged particles.

A method for providing a microwave charged particle source using an antenna is provided according to another embodiment of the invention. The antenna can be surrounded by a dielectric layer. And a containment shield can partially surround the dielectric layer. In some embodiments, the containment shield can include an aperture. And an extraction grid can be coupled to the aperture of the containment shield. The method can include generating microwaves with the antenna, flowing gases inside the containment shield, forming charged particles from the gases with generated microwaves, applying an electrical voltage to the extraction grid to extract the charged particles, and/or outputting the charged particles from the grid.

Additional embodiments and features are set forth in part in the description that follows, and in part will become apparent to those skilled in the art upon examination of the specification or may be learned by the practice of the invention. A further understanding of the nature and advantages of the present invention may be realized by reference to the remaining portions of the specification and the drawings.

The following detailed description together with the accompanying drawings will provide a better understanding of the nature and advantages of the present invention.

### BRIEF DESCRIPTION OF THE DRAWINGS

FIG. 1 illustrates a top view of an exemplary linear microwave ion source according to embodiments of the invention.

FIG. 2 illustrates a sectional view of an exemplary linear microwave ion source according to embodiments of the invention.

FIG. 3 shows an exemplary ion source with a containment shield surrounding two antennas according to embodiments of the invention.

FIG. 4 illustrates an exemplary nonlinear microwave ion source according to embodiments of the invention.

FIG. 5 is a flow diagram illustrating steps for providing a microwave charged particle source according to embodiments of the invention.

### DETAILED DESCRIPTION OF THE INVENTION

Embodiments of the invention provide device and methods for depositing low energy plasma species using a microwave plasma source. In some embodiments, a plasma with low plasma species energy can be formed using a coaxial microwave source. And an extraction grid can be used to provide the proper energy to the plasma species in order to deposit the plasma species on a substrate.

Microwave Plasma

In comparison with typical radio frequency (RF) coupled plasma sources microwave plasma sources can be used to achieve higher plasma densities (e.g., ˜10¹² ions/cm³) and higher deposition rates. These improvements can be a result of improved power coupling and absorption at 2.45 GHz when compared to a typical radio frequency (RF) coupled plasma source at 13.56 MHz. One drawback of using RF plasma is that a large portion of the input power is dropped across the plasma sheath (dark space). By using microwave plasma, a narrow plasma sheath can be formed and more power can be absorbed by the plasma for creation of radical and ion species. This can increase the plasma density and can provide a narrow energy distribution by reducing collision broadening of the ion energy distribution.

Microwave plasma sources can also have other advantages, such as providing a lower ion energy with a narrow energy distribution. For instance, microwave plasma may have low an ion energy of 0.1-25 eV. This can lead to lower damage when compared to processes that uses RF plasma. In contrast, standard planar discharge sources can have ion energy of about 100 eV with a broader distribution in ion energy. This can lead to higher damage, as the ion energy exceeds the binding energy for most materials of interest. This can ultimately inhibit the formation of high-quality crystalline thin films through the introduction of intrinsic defects. With low ion energy and narrow energy distribution, microwave plasma can help in surface modification and/or can improve coating properties.

One potential drawback associated with microwave plasma source technology in the vacuum coating industry was the difficulty of maintaining homogeneity during the scale up from small wafer processing to very large area processing. Microwave reactor designs in accordance with embodiments of the invention address these problems. Arrays of coaxial plasma linear or nonlinear sources can be used to deposit substantially uniform coatings of ultra large area (e.g., greater than 1 m²) at high deposition rate to form dense and thick films over planar or non-planar substrates (e.g., 5-10 μm thick). For deposition over non-planar substrates of large areas, more details are provided in U.S. Patent Application No. 61/224,234, entitled “Curved Surface Wave Fired Plasma Line for Coating of 3 Dimensional Substrates” by Michael Stowell,” filed on Jul. 9, 2009. The entire contents of the foregoing application are herein incorporated by reference for all purposes.

Ion Beam Assisted Deposition and Stress in Deposited Films

Nonconductive and conductive films deposited utilizing PVD, CVD, and/or PECVD sources and/or processes have been achieved with many types of power sources and system configurations. Most of these sources utilize microwaves, HF, and/or VHF energy to generate the excited plasma species, such as radicalized atoms, electrons, and ions. Depending upon how films are deposited and the process conditions under which the films are deposited, these films can experience a tensile stress, a compressive stress, a thermal stress, and/or an intrinsic stress. These stressed can be formed because of external and internal mechanisms.

A thermal stress in thin films may result from differences in thermal expansion. Such films are usually deposited at temperatures above room temperature. Upon cooling from an elevated deposition temperature to room temperature, the thermal stress is induced from a difference in thermal expansion coefficients of the substrate and the film.

An intrinsic stress may result from differences in microstructure of a deposited film. When temperature of a substrate is lower than 20% of melting points of the substrate, the intrinsic stress may dominate because of incomplete structural ordering. The differences may be produced during deposition in atomic spacing, grain orientation or size, and even implanted or trapped gaseous impurities, such as argon. These variations in microstructure depend strongly on processing conditions.

A tensile stress may result from microvoids formed in a thin film, because there is an attractive interaction of atoms across the microvoids. The thin film has a tendency to become smaller than the substrate. As a result, the thin film would be stretched to fit to the substrate and experience a tensile stress.

A compressive stress may be formed when heavy ions or energetic particles strike a film during deposition process. Impacts from the heavy ions could make the film denser and/or pack atoms more closely. Therefore, the film tends to be larger than the substrate. As a result, the film is compressed to fit to the substrate and experiences a compressive stress.

Planar defects are produced as a result of stresses, such as edge dislocations consisting of an extra partial plane of atoms. If one of the stresses is present in a deposited film, stress relief may cause cracking, buckling, or film distortion, among others. Hence, it is desirable to minimize stress in films.

One application of the ion source is ion beam assisted deposition (IBAD). In kinetically limited conditions, ions of low energies could help reduce the various stresses by adding energy in the Ion Beam Assisted Deposition (IBAD). Film depositions require arriving atoms to be grown on a substrate to have high enough energy such that an Ehrlich barrier may be overcome to allow the arriving atoms to have high enough surface mobility. Energies above this Ehrlich barrier could allow a void-free growth, defect free growth, void-free deposition, or defect free deposition to occur. The arriving atoms may cross over an energy barrier to arrive at the lowest energy locations to fill voids such that a defect free growth or deposition may occur.

Coaxial Microwave Ion Source

According to embodiments of the invention, ion sources may be used as low energy ion source, or an IPVD microwave source. The ion sources may also be utilized in ion beam assisted deposition. A coaxial microwave ion source may provide ions, electrons, and radicalized atomic species.

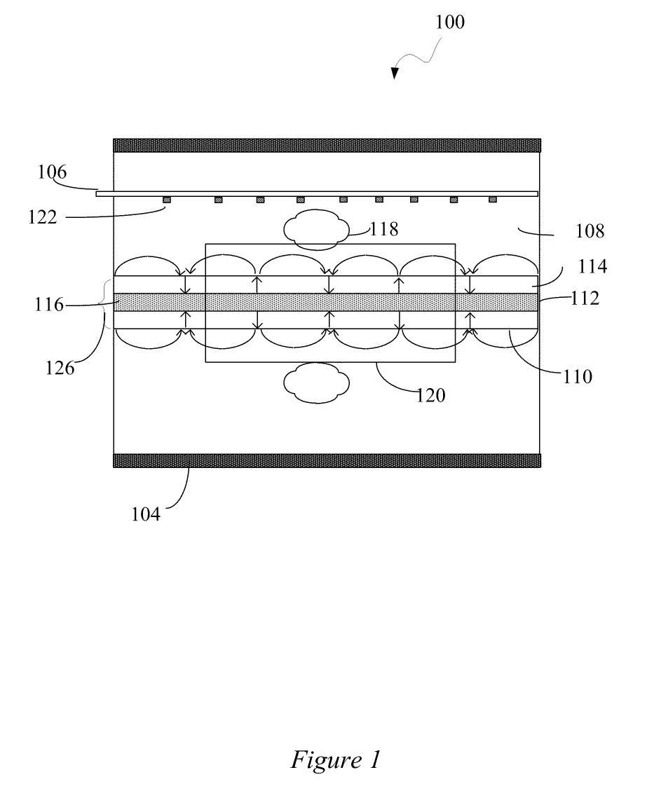

FIG. 1 illustrates a simplified diagram showing coaxial microwave ion source 100. Ion source 100 can include, among others, coaxial microwave line source 126, containment shield 104, and carrier gas line 106 with multiple perforated holes 122 for providing carrier gases. Coaxial microwave line source 126 can include antenna 112, microwave source 116, which inputs microwave into antenna 112, and outer dielectric layer 110 surrounding antenna 112. Dielectric layer 110 may be made of quartz and can serve as a barrier between vacuum pressure 108 and atmospheric pressure 114 inside dielectric layer 110. The atmospheric pressure can aide in cooling antenna 112. Cooling gases between the antenna and the barrier layer may include air and/or nitrogen, among other gases.

Carrier gas line 106 may be located between coaxial microwave line source 126 and a portion of containment shield 104. In some embodiments, carrier gas line 106 can be disposed above coaxial microwave line source 126. Through perforated holes 122, carrier gases flow inside containment shield 104.

Electromagnetic waves can be radiated through dielectric layer 110 inside containment shield 104. Plasma 118 may be formed over the surface of dielectric layer 110. Plasmas that are excited by propagation of electromagnetic surface waves are called surface wave-sustained plasmas. The surface wave may generate a uniform plasma in volumes that have lateral dimensions extending to a few wavelengths. For example, for a microwave of 2.45 GHz in vacuum, the corresponding wavelength can have a lateral dimension of about 12.2 cm. Electromagnetic waves cannot propagate in over-dense plasmas (e.g., with a plasma density of 10¹² ions/cm³ or higher). The electromagnetic waves are reflected at the plasma surface because of a skin effect. The skin or penetration depth δ may be in an order of a few microns. Instead of electromagnetic waves traversing the plasma, the conductivity of the plasma can enable the electromagnetic waves to propagate along the plasma surface. The electromagnetic wave energy can be transferred to the plasma by an evanescent wave that enters the plasma perpendicularly to the surface of the plasma and decays exponentially with the skin depth. Hence, the plasma is heated so that plasma density is increased.

Containment shield 104 can include aperture 120 that allows the ions, electrons, and/or radicals to exit containment shield 104. In a specific embodiment, coaxial microwave line source 126 may be about 1 m long. An array of line sources 126 may also be used. An extraction grid may be placed contiguous to aperture 120 to accelerate ions or electrons before they exit containment shield 104.

Containment shield 104 may be made of a dielectric material (e.g., Al₂O₃, quartz, or pyrex). A few aspects of using a plasma containment shield around an antenna or a plurality of antennas are discussed here. First, a pressure difference may be present between the internal pressure of the containment shield and external pressure of the containment shield, with the internal pressure being higher than the external pressure. This pressure can allow more processing flexibility than without using the containment shield. With increased pressure inside the containment shield, plasma species or radicals may have more collisions and thus higher radical density. With lower pressure outside the containment shield, the mean free path increases for plasma species or radicals resulting in an increased deposition rate.

Furthermore, because the shield helps increase the collisions among the radicals by confining the radicals within the containment shield without losing the radical species the plasma containment shield may help increase radical density and form homogeneous plasma. The increase in the radical density and/or the improvement in radical homogeneity can be particularly noticed in the radical direction.

In addition, by using a containment shield, the volume of the gas inside the plasma containment shield may be more fully ionized and thus may produce more radicals so that ionization efficiency may be improved. For instance, the inventors performed experimental tests to demonstrate that the ionization efficiency may be improved from 65% to 95% by using a plasma containment shield. circular containment shield is shown in FIG. 1. Other shapes of containment shield may be used. For example, any containment shield shape can be used, such as those included in U.S. patent application Ser. No. 12/238,664, entitled “Microwave Plasma Containment Shield Shaping” by Michael Stowell. The entire contents of the above US patent application are incorporated herein for illustration purpose, a by reference for all purposes.

A controller may be used to control activities and operating parameters of the ion source, such as flow of gases, mixture of gases, pressure, and microwave power levels.

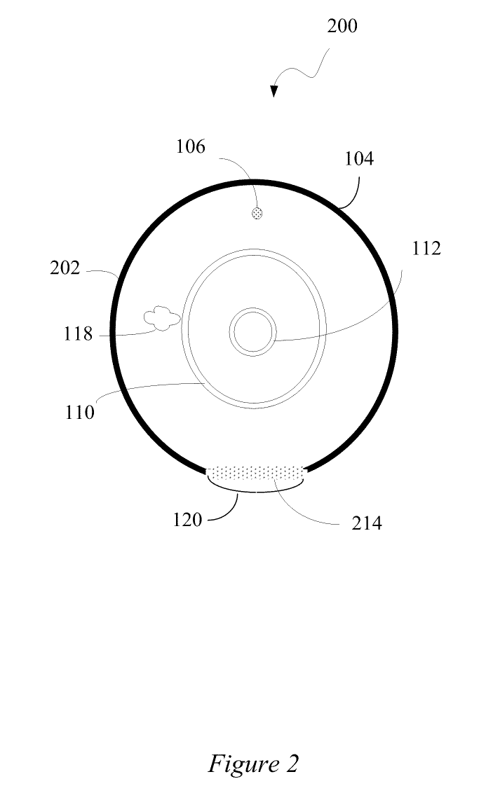

FIG. 2 shows a sectional view of coaxial microwave ion source 200 according to some embodiments of the invention. Coaxial microwave ion source 200 can include containment shield 104 partially surrounding antenna 112. Containment shield 104, in this example, has a generally circular cross-section. Any other shaped cross-section can be used. Antenna 112 can include a waveguide 112 that acts as a microwave source. In some embodiments, coaxial microwave ion source 200 can also include dielectric tube or layer 110 outside antenna 112 acting as a pressure isolation barrier. Air or nitrogen can be filled in the space between dielectric tube 110 and antenna 112. This air or nitrogen can be useful for cooling the antenna. The first pressure inside dielectric tube 110 may be set at about one atmospheric pressure give or take about 10%. Containment shield 104 is outside dielectric tube 110 for containing plasma 118 that is formed from sputtering agents provided from carrier gas line 106. Plasma 118 can exit through aperture 120 near the bottom of containment shield 104.

Ion source 200 can also include extraction grid 214. Extraction grid 214 can be placed contiguous with aperture 120 (e.g., on, near, next to, touching, at, or coupled with aperture 120). In some embodiments, extraction grid 214 can be in contact with containment shield 104, while in other embodiments, extraction grid 214 is not in contact with containment shield 104.

Extraction grid 214 can be used to energize and extract plasma species such as ions and/or electrons from the plasma created around dielectric tube 110. In some embodiments of the invention, a DC, RF, or AC potential may be applied to extraction grid 214 in order to accelerate and control the direction of ions or other plasma species out of containment shield 104. By controlling aperture 120, the direction of the ion source may be controlled. The aperture may have various sizes and shapes. Those skilled in the art will recognize many variations and modifications consistent with the present invention.

In most microwave based processes plasma species may have less than 1 eV of energy. This low ion energy may not be enough for many applications. The ion energy of plasma species can be increased using extraction grid 214. By placing extraction grid 214 over aperture 120 and applying a potential the plasma species can be accelerated and directed toward a substrate. Moreover the amount of ion energy provided is directly proportional to the amount of potential applied to extraction grid 214. Thus, a controller or user can adjust the potential to change the ion energy of the plasma species.

Extraction grid 214 can be made of any conductive material with voids through which energized ions can pass. For example, extraction grid 214 can be formed from a mesh like material that includes a grid of voids spread throughout extraction grid 214. Or extraction grid 214 can be a single or laminate sheet or plate of conductive material with a plurality of voids formed throughout the sheet or plate. When an electric potential is applied to extraction grid 214 an electric filed is created that can attract low energy ions from plasma 118. This electric field can increase the energy of plasma ions so that the ions can pass through the voids in the extraction grid and be deposited on a substrate positioned near aperture 120. Thus the number and size of the voids in extraction grid 214 can be arranged to allow ions to pass through extraction grid 214. Because the electric filed is proportional to the potential applied to the extraction grid, the energy of the plasma species can be tuned by tuning the applied potential. In some embodiments, extraction grid 214 can be formed from Tungsten or an alloy thereof.

In the various embodiments of the invention the substrate may be either horizontally positioned or vertically positioned in a processing chamber. The coaxial microwave ion source may also be disposed horizontally or vertically inside the processing chamber to match a respective configuration of the substrate. For vertical configurations of ion sources in a deposition system, details are provided in U.S. Patent Application No. 61/224,371, entitled “Simultaneous Vertical Deposition of Plasma Displays Layers,” filed on Jul. 9, 2009. The content of the foregoing application is herein incorporated by reference for all purposes.

In one embodiment, the microwave power plasma source could be used as an ion source. Such an ion source could produce high ion densities with various electron voltages, depending on the potential applied to extraction grid 214.

Although extraction grid 214 could be constructed from many materials consistent with the present invention, using etch resistant materials such as tungsten may help prevent any sputtering effects on extraction grid 214. Moreover, by allowing extraction grid 214 to heat up, deposition on extraction grid 214 and/or any subsequent flaking, may also be prevented or mitigated. It should be noted that extraction grid 24 can also be used to extract electrons.

Ion source 200 may also include microwave reflector 202 outside containment shield 104. Microwave reflector 202 may help reduce loss of microwave energy beyond the containment shield and thus enhance the ionization efficiency.

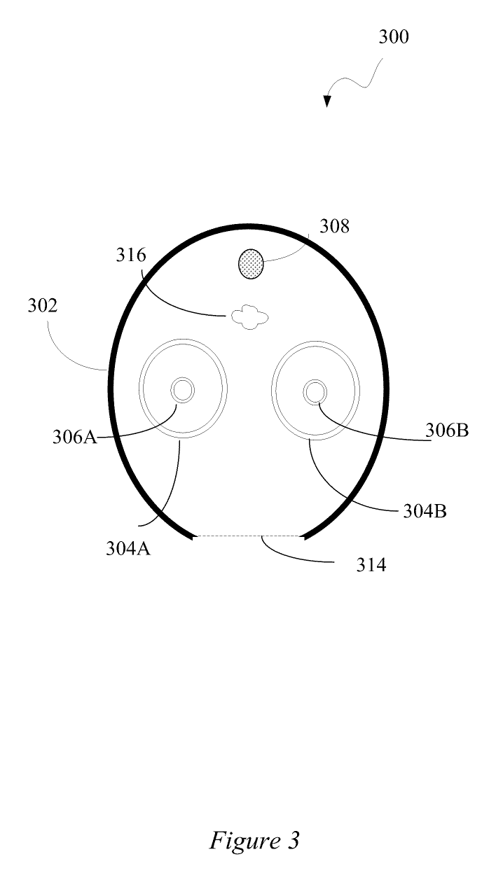

FIG. 3 shows ion source 300 with containment shield 302 surrounding two antennas 306A and 306B. Ion source 300 is similar to the source shown in FIG. 2, except two antennas 306A and 306B are provided inside containment shield 302. Such an ion source may provide increased microwave power and/or increased ion efficiency.

Each antenna can include a waveguide. Ion source 300 can also include respective dielectric tubes 304A and 304B as a pressure isolation barrier for antennas 306A and 306B. The two antennas may be symmetrically positioned inside containment shield 302. Air or nitrogen may be filled in the space between dielectric tubes 304A-B and antennas 306A-B for cooling the antenna. For example, the first pressure inside dielectric tubes 304A-B may be one atmospheric pressure. Containment shield 302 can be located outside dielectric tubes 304A-B for containing plasma 316 that is formed from sputtering agents coming from a carrier gas line 308 inside the containment shield. Plasma 316 can come through aperture 314. The ion source may be an array of ion sources within containment shield 302. U.S. patent application Ser. No. 12/238,664, entitled “Microwave Plasma Containment Shield Shaping” by Michael Stowell shows some more detail on containment shields. The entire contents of the above US patent application are incorporated herein by reference for all purposes. Those skilled in the art will recognize many variations and modifications consistent with the present invention.

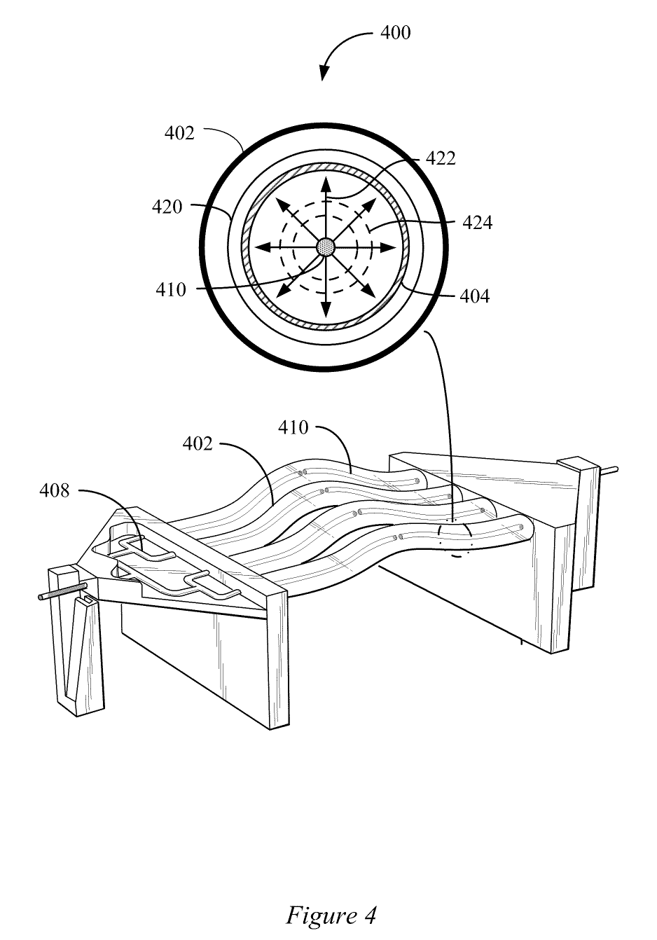

According to embodiments of the present invention, the coaxial microwave ion source may be in a nonlinear form. For example, FIG. 4 shows a schematic of coaxial microwave ion source 400 including curved waveguide 410 with curved containment shield 402, and cascade coaxial power provider 408. Using curved coaxial microwave ion source 400, microwave power can be radiated into a processing chamber in a transversal electromagnetic (TEM) wave mode.

A cross sectional view of coaxial microwave source 400 is provided. Such an antenna can be used to radiate microwaves at a frequency of 2.45 GHz. The radial lines represent an electric field 422 and the circles represent a magnetic field 424.

Microwave ion source 400 (both curved and non-curved) can includes antenna 410 surrounded by dielectric tube 404 forming a pressure isolation barrier, between the atmospheric pressure of the antenna cooling from the chambers internal lower pressure. The curved dielectric tube 404 is coaxial with antenna or waveguide 410. The curved tube is made of dielectric material, such as quartz or alumina having high heat resistance and a low dielectric loss. The microwaves propagate through the air to the curved dielectric tube 404 and then leak through curved dielectric tube 404 to form an outer plasma conductor 420 outside curved dielectric tube 404. Such a wave sustained near the coaxial microwave source is a surface wave. Microwaves can propagate along curved conductor 410 and go through a high attenuation by converting electromagnetic energy into plasma energy. In some embodiments, quartz or alumina may not be present outside the microwave source.

A support gas pipe can be used to provides the gas used to produce ions, electrons, and radicalized species used in ionization process. The Support gas pipe may provide more than one gas for this purpose. The plasma produced radical species can have multiple loss mechanisms, including, among others, recombination, pumping, fractionalization of precursor gas, inclusion into the growing film. The gas ionization efficiency or plasma efficiency is typically not 100%. Hence, reducing the loss of radicals and or increasing the amount of radicals produced for a given power level can be beneficial in growing films.

By placing a dielectric containment shield around the antenna with a dielectric barrier layer, the volume of gas within this containment shield can be more fully ionized producing more radicalized species than without the shield. One benefit is that the local pressure within this containment shield by the carrier gas being feed into this containment shield can be higher than the volume outside the containment shield. This allows more process flexibility than before for the same power levels and process conditions.

The conductive waveguide may experience thermal distortion due to heating of the antenna in radiating electromagnetic radiation. Material selection of the waveguide may vary with the need to have both good electrical conductivity and good thermal resistance to warp or distortion. In a specific embodiment, the waveguide may be made of titanium coated with gold, where titanium provides good thermal resistance while gold is a very good conductor. In another embodiment, the waveguide may be made of aluminum, stainless steel, copper coated with silver. Different materials may have various electrical conductivity, various resistance to thermal stress or thermal distortion, and cost variation associated with material and fabrication. Those skilled in the art will recognize many variations and modifications consistent with the present invention.

For illustration purposes, the waveguide may have an outer diameter of a few millimeters, such as 6 mm with a wall thickness of 1 to 1.5 mm. The isolation barrier tube may have a larger diameter than the waveguide, for example, an outer diameter of 38 mm with a wall thickness of 3 mm. There may be different ways of making the dielectric tube. In a specific embodiment, the isolation barrier tube may be fabricated by using a sheet of glass having a desired wall thickness. The sheet of glass may be heated by using a flame heater to bend and wrap around a mandrel to form a curved tube of any desired shape. The mandrel may be a metal that can be formed to have the desired shape.

The containment shield may have a relatively larger diameter to provide space for containing a plasma inside. In some embodiments, an outer diameter of the containment shield may be 6 inches with a wall thickness of approximately 0.2 inches. The containment shield may be made of quartz, alumina or a borosilicate glass with low coefficient of thermal expansion such as Pyrex. One of the common fabricating methods is to cast the containment shield in a mold to obtain any desired shape. The containment shield may be further annealed to increase density to achieve required properties or performance.

The waveguide, quartz tube, and/or containment shield may be integrated together by common technologies known in the art after each of the component is fabricated to the desired shape which matches with any desired shape of the substrate.

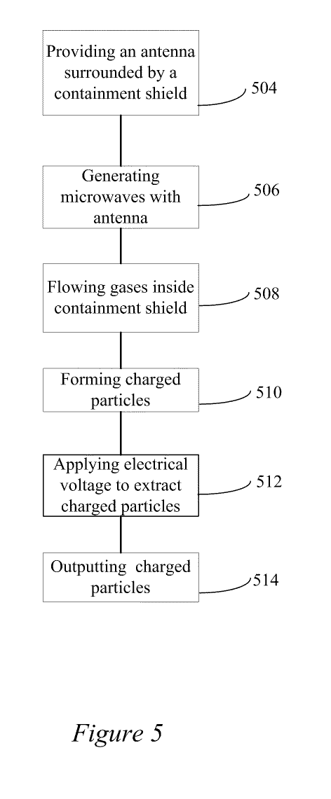

For purposes of illustration, FIG. 5 is a flow diagram of a process that may be used to provide a microwave charged particle source. The process begins with providing a coaxial microwave antenna at block 504. The antenna may be surrounded by a dielectric layer coaxial with the antenna. The dielectric layer can act as a barrier to contain cooling gases around the antenna. The dielectric layer may be partially surrounded by a containment shield. The containment shield has an aperture that is coupled to a grid for extraction of ions or electrons inside the containment shield.

The process continues by generating microwaves with the antenna at block 506. Forming charged particles is initiated by flowing gases into the containment shield at block 508. The gases may act as a sputtering agent, including one or more fluent gas such as helium, argon, nitrogen (N₂), hydrogen (H₂), among other fluent gases. For example, the gas may be provided with a flow of H₂ or with a flow of an inert gas, including a flow of He or even a flow of a heavier inert gas such as Ar. The level of sputtering provided by the different fluent gases is inversely related to their atomic mass (or molecular mass in the case of H₂), with H₂ producing even less sputtering than He. Flows may sometimes be provided of multiple gases, such as by providing both a flow of H₂ and a flow of He into the containment shield. Alternatively, multiple gases may sometimes be used to provide the fluent gas, such as when a flow of H₂/He is provided into the containment shield.

As indicated at block 510, a plasma containing charged particles, such as ions and electrons, is formed from the gases. Plasma conditions (e.g., microwave power, microwave frequencies, pressure, temperature, carrier gas partial pressures, etc.) may vary to meet the need of a particular application. In some embodiments, the plasma may be a high-density plasma having an ion density that exceeds 10¹² ions/cm³. The environment within the processing chamber may also be regulated in other ways in some embodiments, such as by controlling the pressure within the containment shield, controlling the flow rates of the gases and where they enter the containment shield, controlling the power used in generating the plasma, and the like.

The process continues by applying an electrical voltage to the extraction grid to extract the charged particles, such as ions or electrons, as indicated at block 512 and outputting the charges particles from the extraction grid at block 514.

Those of ordinary skill in the art will realize that specific parameters can vary for different processing chambers and different processing conditions, without departing from the spirit of the invention. Other variations, among others, including shapes or geometry of coaxial microwave ion sources and containment shield, aperture of the containment shield, extraction grid, material selections for waveguide, dielectric tube, containment shield, and reflector, and configuration of array of ion sources, will also be apparent to persons of skill in the art. These equivalents and alternative are intended to be included within the scope of the present invention. Therefore, the scope of this invention should not be limited to the embodiments described, but should instead be defined by the following claims.

Thus, although the invention has been described with respect to specific embodiments, the invention is intended to cover all modifications and equivalents within the scope of the following claims.

What is claimed is:

1. A microwave charged particle source comprising:
a coaxial antenna for generating microwaves;
a dielectric layer surrounding the antenna;
a first gas line disposed outside the dielectric layer for providing sputtering gases;
a containment shield partially surrounding the dielectric layer, the containment shield comprising an aperture, wherein the first gas line is disposed at least partially within the containment shield, and wherein charged particles are formed from gases sputtered from the first gas with microwaves generated by the coaxial antenna; and
an extraction grid disposed contiguous to the aperture of the containment shield, wherein the charged particles are accelerated under an electric field created from a voltage applied to the extraction grid.

2. The microwave charged particle source of claim 1, wherein the coaxial antenna comprises:
a waveguide for converting an electromagnetic wave into a surface wave and radiating the surface wave in a radial direction; and
a dielectric tube, the dielectric tube surrounding the waveguide and being substantially coaxial with the metallic waveguide, wherein a microwave generator is coupled to the metallic waveguide for providing the electromagnetic wave.

3. The microwave charged particle source of claim 2, wherein the waveguide comprises a first metal or metal alloy coated with a second metal, wherein the first metal is characterized by dimensional stability and resistance to thermal distortion and the second metal is characterized by electrical conductivity.

4. The microwave charged particle source of claim 3, wherein the first metal or metal alloy comprises a material selected from the group consisting of titanium, aluminum, copper, and stainless steel.

5. The microwave charged particle source of claim 3, wherein the second metal comprises gold or silver.

6. The microwave charged particle source of claim 1, wherein the coaxial antenna and the containment shield are non-linear.

7. The microwave charged particle source of claim 1, wherein the extraction grid comprises tungsten.

8. The microwave charged particle source of claim 1, further comprises a second gas line for providing cooling gas in a space between the antenna and dielectric layer.

9. The microwave charged particle source of claim 1, wherein the cooling gas comprises air or nitrogen.

10. The microwave charged particle source of claim 1, the microwave charged particle source further comprises a microwave reflector.

11. The microwave charged particle source of claim 1, wherein the dielectric layer comprises quartz.

12. The microwave charged particle source of claim 1, wherein the containment shield comprises quartz or alumina.

13. The microwave charged particle source of claim 1, wherein the sputtering gases comprise a material selected from the group consisting of helium, hydrogen, argon and nitrogen.

14. A method for providing a microwave charged particle source comprising:
providing an antenna, wherein:
the antenna is surrounded by a dielectric layer;
a containment shield partially surrounds the dielectric layer; and
the containment shield has an aperture, wherein a grid is coupled to the aperture of the containment shield;
generating microwaves with the antenna;
flowing gases inside the containment shield;
forming charged particles from the gases with generated microwaves;
applying an electrical voltage to the extraction grid to extract the charged particles; and
outputting the charged particles from the grid.

15. The method of claim 14, further comprising reflecting the microwaves back to be inside the containment shield with a reflector, wherein the reflector surrounds the containment shield and has an open portion that matches with the aperture of the containment shield.

16. The method of claim 14, further comprising cooling the antenna with flow of a second gas.

17. The method of claim 14, wherein the extraction grid comprises tungsten.

18. The method of claim 14, wherein the electrical voltage is supplied by a power supply configured to supply at least one of a DC, AC or RF power.

19. A plasma source comprising:
a plasma source configured to produce low energy plasma;
a containment shield at least partially surrounding the plasma source, the containment shield comprising an aperture; and
an extraction grid disposed contiguous with the aperture and configured to accelerate plasma species when an electrical potential is applied to the extraction grid.

20. The plasma source according to claim 20, wherein the plasma source comprises a microwave antenna and a gas source.
